(19) United States
(12) Patent Application Publication
(10) Pub. No.: US 2002/0182924 A1
(43) Pub. Date: Dec. 5, 2002

(54) Connector for electronic appliance

(76) Inventor: Seung-Kee Mo, Seoul (KR)

Correspondence Address: RABIN & CHAMPAGNE, PC, 1101 14TH STREET, NW, SUITE 500, WASHINGTON, DC, 20005, US

(21) Appl. No.: 09/871,704

(22) Filed: Jun. 4, 2001

(51) Int. Cl. H01R 13/627

(52) U.S. Cl. 439/358

(57) ABSTRACT

A connector having a push-type or sliding-type connecting and separating member is disclosed. The connector includes a socket, a plug and the push-type or sliding-type connecting and separating member. The socket has a first case provided with a spiral groove and an inserting hole, a first nut mounted at an end of the first case, a locking groove formed at an inner portion of the first nut and a female contact formed at a central portion of the first case. The plug has a second case having a stepped cylindrical shape, a male contact formed at central portion of the second case to be contacted with the female contact and a second nut mounted at an end of the second case.

### TECHNICAL FIELD

The present invention relates to a connector for an electronic appliance, more particularly to a connector for an electronic appliance having a push-type or a slide-type connecting and separating member to enhance the connection stability of the connector and to easily execute the connection and separation of the connector.

### BACKGROUND ART

In general, connectors applied to electronic equipment such as medical appliances are connecting parts used to connect several parts of the electronic equipment in serial order. That is, the connectors connect one circuit of the electronic equipment to another circuit of the electronic equipment. Such connectors are disclosed at U.S. Pat. No. 6,027,364 (issued to Masaru Fukuda) and U.S. Pat. No. 6,039,591 (issued to Richard N. Marsh et. al.). Those connectors generally have male parts and female parts coupled together.

However, when connecting or separating parts of the electronic equipment by connecting or separating sockets and plugs of the connectors, the sockets and the plugs of those connectors may not be easily connected or separated from each other and the connection stability between the sockets and the plugs may be reduced. Also, the connection stability between the plugs and the cables of the electronic equipment may be reduced.

Furthermore, such connectors may not be applied to medical electronic equipment that should meet the safe standard for medical appliances set forth by the IEC601, though the connectors can be used for communication devices.

To solve such problems concerning the conventional connector, a connector for medical appliances is disclosed by the Radel Co. of Germany.

FIG. 1 is a cross sectional view for showing the conventional connector for a medical appliance provided by the Radel Co.

Referring to FIG. 1, the connector includes a socket 100 having a female contact 125 formed at a central portion therein and a plug 110 having a male contact 165 formed at a central portion therein.

The socket 100 has a spiral groove 107 formed at outer peripheral portion of the socket 100 and a front nut 105 formed at an end portion of the socket 100. A hexagonal nut 115 is combined with the front nut 105. The female contact 125 is formed at the central portion of the socket 100 and the female contact 125 corresponds to the male contact 165 of the plug 110. An insulating layer 120 is wound around the female contact 125. Also, another insulating layer 150 is formed around the male contact 165.

A latch member 140 is formed at an outer peripheral portion of the plug 100. The latch member 140 has a protruding portion 145 corresponding to a groove 130 formed at an inner peripheral portion of the socket 100. Also, a collet 155 for the connection of the electric wire is formed behind the male contact 165 and a collet nut 160 is installed in order to fix the collet 155.

FIGS. 2A and 2B are cross sectional views for illustrating the connection and separation of the conventional connector in FIG. 1.

Referring to FIG. 2A, in the case of coupling the plug 110 into the socket 100, the latch member 140 having the protruding portion 145 is inserted into the socket 100, and then the protruding portion 145 of the latch member 140 is inserted into the groove 30 of the socket 100 thereby connecting the plug 110 to the socket 100.

In the meantime, when the plug 110 is separated from the socket 100, the latch member 140 is pulled toward the plug 110 as shown in FIG. 2B, and then the protruding portion 145 of the latch member 140 is detached from the groove 130 of the socket 100 whereby separating the plug 110 from the socket 100.

Though the socket and the plug are easily connected or separated from each other, the connector of the Radel, however, has several problems as follows.

As for the above-described connector, the plug and the socket may not be easily connected or separated when the collet nut is strongly tightened for fixing the electrical wire connected to the pins formed in the plug. That is, the collet nut should be strongly tightened for preventing the electrical wire from detaching but the connection and separation processes of the connector are hardly executed when the collet nut is strongly tightened.

Though the female contact is positioned from the end of the socket by an interval of about 3 mm in order to ensure the connection stability of the connector, the plug and the socket do not automatically connect or separate when the female contact exists in such a condition. Also, the connector may not be minimized since the plug is protruded from the socket when the female contact is positioned from the end of the socket by an interval of about 3 mm. In general, a connector has several advantages that apply to a system assembly when the connector has small dimensions. Such case may be identically applied when the positions of the pins protrude from the end of the plug.

Furthermore, the connector made by Radel has a complex structure and the manufacturing cost may increase since the connector includes the latch member having a protruding portion to move forward and backwards.

### DISCLOSURE OF INVENTION

Considering the above-mentioned problems, it is an object of the present invention to provide a connector for an electronic appliance having a push-type or a sliding-type connecting and separating member so as to easily connect a plug to a socket and to easily separate the plug from the socket.

It is another object of the present invention to provide the connector for an electronic appliance having the push-type or a sliding-type connecting and separating member in order to enhance the connection stability of the plug to the socket and to easily fix an electric wire to the connector.

To achieve the above-mentioned objects of the present invention, there is provided a connector for an electronic appliance comprises a socket and a plug.

The socket comprises a first case, a first nut, a locking groove and a female contact.

The first case has a spiral groove at an outer peripheral portion of the first case and an inserting hole at an inner peripheral portion of the first case. The first nut is mounted at an end of the first case and the locking groove is formed at a first inner peripheral portion of the first nut. The female contact is formed at a central portion of the first case.

The plug comprises a second case, a male contact, a connecting and separating means and a second nut.

The second case has a stepped cylindrical shape and the male contact is formed at central portion of the second case to be contacted with the female contact. The connecting and separating means corresponds to the locking groove and is mounted at a portion where the second case is inserted into the socket. The second nut is mounted at an end of the second case.

Preferably, the connector further comprises a first insulating means formed at a peripheral portion of the female contact and a second insulating means formed at a peripheral portion of the male contact. In this case, the interval between the female contact and an outer end of the socket is about 4mm.

According to one preferred embodiment of the present invention, the connecting and separating means is a push-type connecting and separating member including a latch formed at a front portion of the member which corresponds to the locking groove.

Preferably, the push-type connecting and separating member is comprised of an elastic material. At that time, the push-type connecting and separating member is a plastic button or a metal button.

According to another preferred embodiment of the present invention, the connecting and separating means is a slide-type connecting and separating member having two balls corresponding to the locking grooves when two locking grooves are formed at inner peripheral portion of the first case.

According to the present invention, the plug can be easily connected to or separated from the socket and the connection stability of the electric wire can be enhanced without regard to the tightness condition of the nut for fixing the electric wire since the connector of the present invention includes the push-type or sliding-type connecting and separating member. The connecting and the separating processes are accomplished by using the push-type or the sliding-type connecting and separating member.

Also, the connector of the present invention can sufficiently meet the safety standards for medical appliances because the female contact is positioned from the end of the socket by the interval of about 4 mm. Therefore, the connector according to the present invention can be widely applied to various electric and electronic appliances such as communication devices and medical apparatuses.

### BRIEF DESCRIPTION OF DRAWINGS

The above objects and other advantages of the present invention will be more apparent by describing in detail the preferred embodiments thereof with reference to the attached drawings, in which:

FIG. 1 is a cross sectional view for showing the conventional connector for a medical appliance;

FIGS. 2A and 2B are cross sectional views for illustrating the connection and separation of the conventional connector;

FIGS. 3A and 3B are cross sectional views for illustrating a connector for an electronic appliance according to one preferred embodiment of the present invention; and

FIG. 4 is a cross sectional view for showing a connector for an electronic appliance according to another preferred embodiment of the present invention.

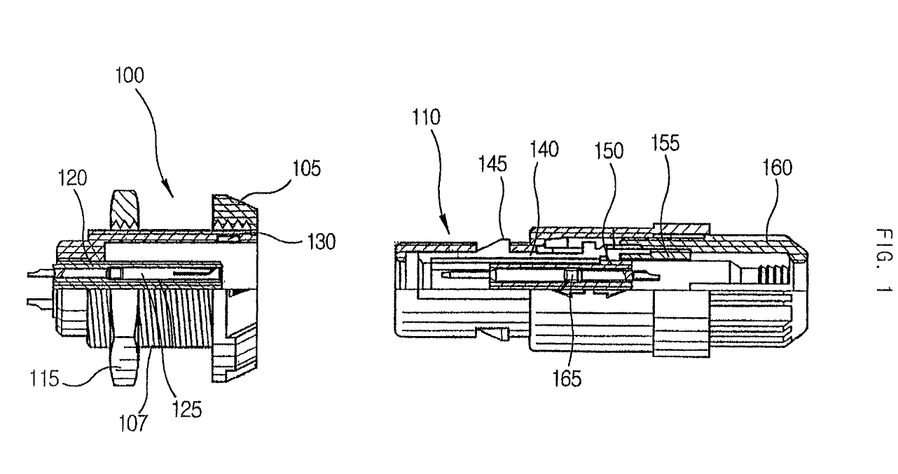

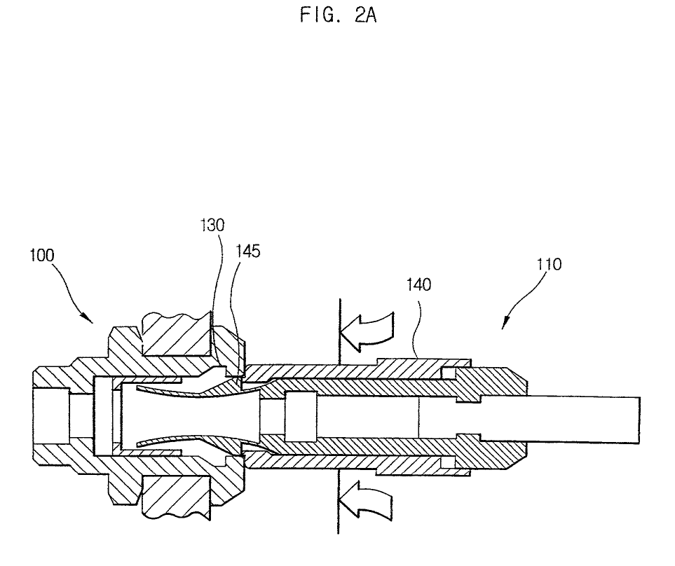

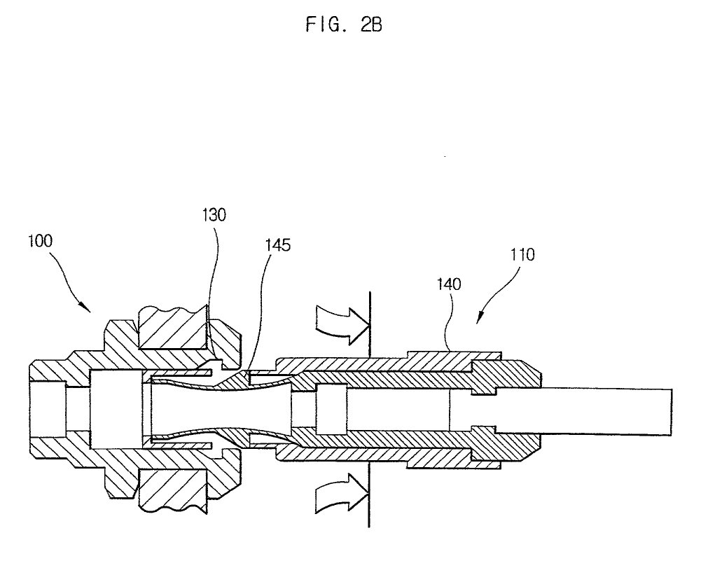

### BEST MODES FOR CARRYING OUT THE INVENTION

Hereinafter, the preferred embodiments of the present invention will be explained in more detail with reference to the accompanying drawings.

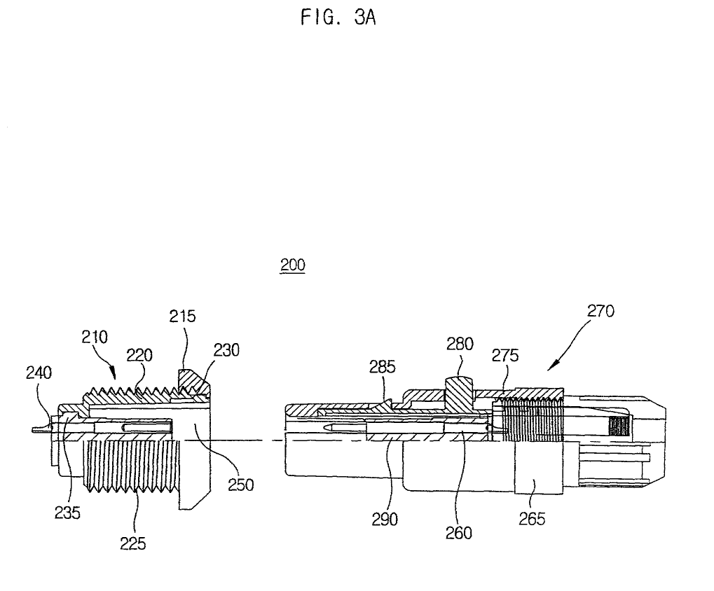

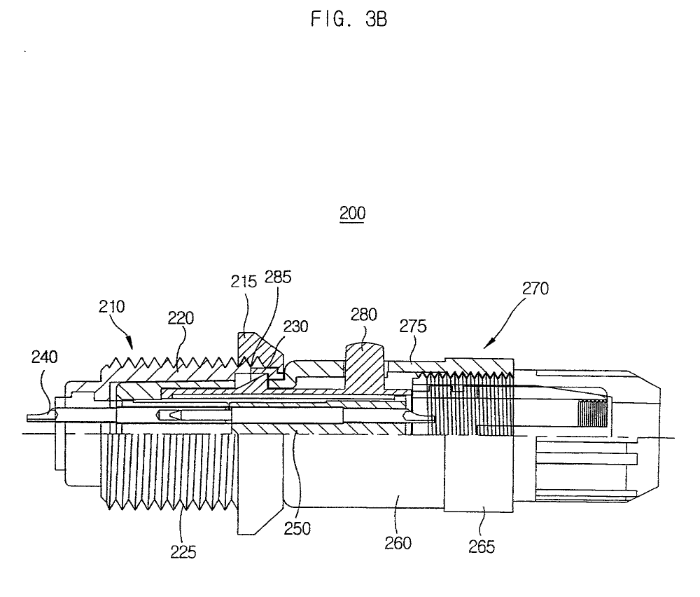

FIGS. 3A and 3B are cross sectional views for illustrating a connector for electronic appliance according to first embodiment of the present invention. More particularly, FIG. 3A is a cross sectional view for showing a socket and a plug before the socket and the plug are combined and FIG. 3B illustrates the socket and the plug after the socket and the plug are coupled together.

Referring to FIGS. 3A and 3B, a connector 200 according to one embodiment of the present invention includes a socket 210 and a plug 270.

The socket 210 has a female contact 240 formed at the central portion of the socket 210 and the plug 270 has a stepped cylindrical shape corresponding to the socket 210. Also, the plug 270 has a male contact 260 formed at the central portion of the plug 270. The male contact 260 corresponds to the female contact 240 of the socket 210.

The socket 210 further has a first case 220, a first nut 215, a locking groove 230 and a first insulating member 235.

The first case 220 has a spiral groove 225 formed at the outer peripheral surface of the first case 220 and an inserting hole 250 formed at the inner peripheral portion of the first case 220. The inserting hole 250 corresponds to the plug 270 so as to receive the plug 270 therein.

The first nut 215 is mounted at an end portion of the first case 220 to be contacted with the plug 270.

The locking groove 230 is formed at a portion of the inner peripheral portion of the first case 220 for connecting the socket 210 with the plug 270.

The female contact 240 is formed at the central portion of the first case 220 to be combined with the male contact 260 of the plug 270. At that time, the female contact 240 is positioned from the outer end of the socket 210 by an interval of approximately 4 mm. That is, the interval between the outer end of the socket 210 and the female contact 240 is about 4 mm.

In case of the conventional connector, the female contact is positioned from the end of the socket by an interval of about 3 mm so as to ensure the connection and separation of the connector since the latch member moves forward and backward for connecting and separating of the connector. However, according to the present invention, the female contact 240 can be positioned from the outer end of the socket 210 by an interval of about 4 mm because the plug 270 and the socket 210 are connected or separated by means of a push-type connecting and separating member 280.

The plug 270 further comprises a second case 275, the male contact 260, a second insulating member 290, the push-type connecting and separating member 280 and a second nut 265.

The second case 275 has the stepped cylindrical shape for coupling with the socket 210.

The male contact 260 is formed at the central portion of the second case 275 and is connected to the female contact 240 of the socket 210.

The second insulating member 290 is formed at peripheral portion of the male contact 260. The second nut 265 is formed at end of the second case 275.

The push-type connecting and separating member 280 has a latch 285 corresponding to the locking groove 230 of the socket 210. The latch 285 is formed at the front portion of the push-type connecting and separating member 280 and is mounted at a portion where the second case 275 is inserted into the socket 210.

The push-type connecting and separating member 280 is generally comprised of an elastic material for easily connecting and separating the connector 200. Preferably, the push-type connecting and separating member 280 includes a plastic button or a metal button.

When the plug 270 having the push-type connecting and separating member 280 is coupled with the socket 210, the latch 285 of the push-type connecting and separating member 280 is inserted into the locking groove 230 of the socket 210, thereby connecting the plug 270 to the socket 210.

Also, a user pushes the push-type connecting and separating member 280 when the plug 270 is separated from the socket 210, so the latch 285 of the push-type connecting and separating member 280 is detached from the locking groove 230 of the socket 210 by elasticity of the push-type connecting and separating member 280. At that time, the plug 270 can be easily separated from the socket 210 by moving back the plug 270.

According to the connector 200 for electronic appliances of the present embodiment, the second nut 265 having a spiral shape can be tightened strongly for fixing an electric wire connected to several pins (not shown) of the plug 270 since the connecting and the separating processes are executed by using the push-type connecting and separating member 280. Therefore, the connection stability of the electric wire can be greatly enhanced without regard to the tightness of the second nut 265 because the plug 270 and the socket 210 are combined or separated through the push-type connecting and separating member 280.

Also, the connector 200 can sufficiently meet the regulations set forth by the IEC601 since the female contact 240 is positioned from the end of the socket 210 by the interval of about 4 mm.

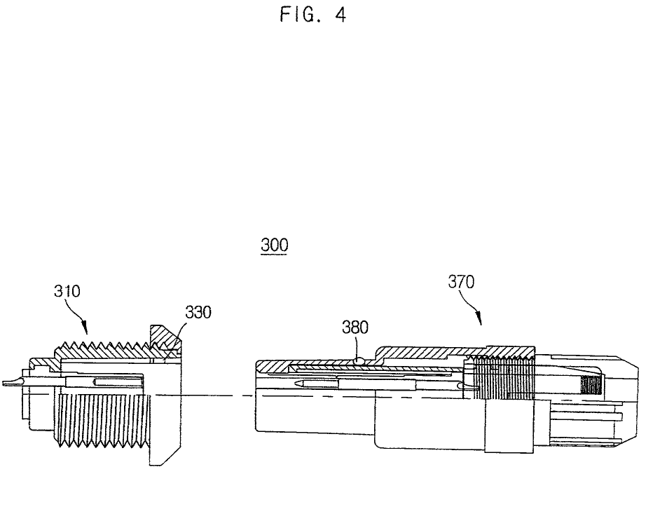

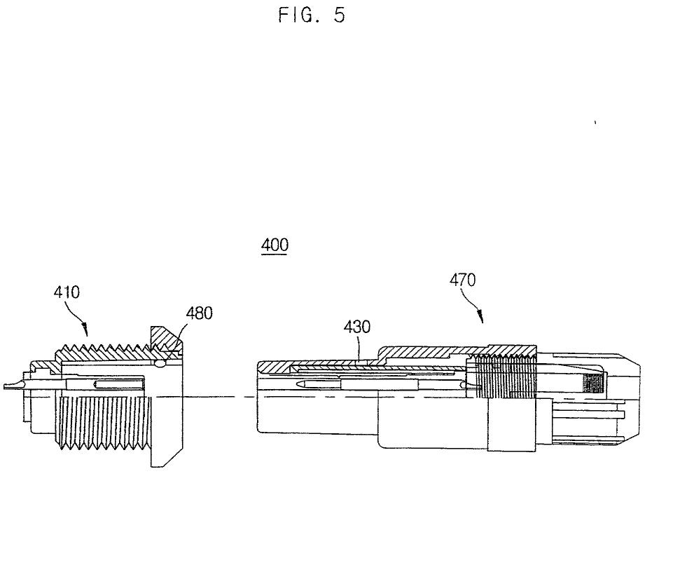

FIG. 4 is a cross sectional view for showing a connector according to the second embodiment of the present invention.

In the connector 300 according to the present embodiment, the descriptions of several elements identical to those of the first embodiment will be omitted with an exception to a sliding-type connecting and separating member 380 of the plug 370 and the two locking grooves 330 of the socket 310.

Referring to FIG. 4, the connector 300 includes the plug 370 having the sliding-type connecting and separating member 380 and the socket 310.

The sliding-type connecting and separating member 380 includes two balls formed at the outer peripheral portions of the plug 370. The socket 310 also has two locking grooves 330 formed at the inner peripheral portions of the socket 310. Those locking grooves 330 respectively correspond to the balls of the sliding-type connecting and separating member 380.

When the plug 370 having sliding-type connecting and separating member 380 is inserted into the socket 310, the balls of the sliding-type connecting and separating member 380 are respectively inserted into the locking grooves 330 of the socket 310, thereby combining the plug 370 with the socket 310.

Meanwhile, when the user moves back the plug 370, the balls of the sliding-type connecting and separating member 380 are revolved to be detached from the locking grooves 330 of the socket 310 so that that the plug 370 is easily separated from the socket 310.

FIG. 5 is a cross sectional view for showing a connector according to the third embodiment of the present invention.

Referring to FIG. 5, the connector 400 according to the present embodiment includes a socket 410 and a plug 470. A sliding-type connecting and separating member 480 having two balls is provided at inner peripheral portions of the socket 410. Two locking grooves corresponding to the balls are formed at outer peripheral portions of the plug 470. Namely, the difference between the second embodiment and the third embodiment is that the sliding type connecting and separating member and the locking grooves are positioned reveresly.

### INDUSTRIAL APPLICABILITY

As it is described above, the plug can be easily connected to or separated from the socket and the connection stability of the electric wire can be enhanced without regard to the tightness condition of the nut for fixing the electric wire since the connector of the present invention includes the push-type or sliding-type connecting and separating member and the connecting and separating processes are accomplished by using the push-type or sliding-type connecting and separating member.

Also, the connector of the present invention can sufficiently meet the safety standards for medical appliances because the female contact is positioned from the end of the socket by an interval of about 4 mm. Therefore, the connector according to present invention can be widely applied to various electric and electronic appliances such as communication devices and medical apparatuses.

While the present invention has been particularly shown and described with reference to preferred embodiments thereof, it will be understood by those skilled in the art that various changes in form and detail may be effected therein without departing from the spirit and scope of the invention as defined by the appended claims.

What is claimed is

1. A connector for an electronic appliance comprising:
a socket having i) a first case provided with a spiral groove at an outer peripheral portion and an inserting hole at an inner peripheral portion, ii) a first nut mounted at an end of said first case, iii) a locking groove formed at a first inner peripheral portion of said first nut and iv) a female contact formed at a central portion of said first case; and
a plug having i) a second case having a stepped cylindrical shape, ii) a male contact formed at a central portion of said second case to be contacted with said female contact, iii) a connecting and separating means corresponding to said locking groove and being mounted at a portion where said second case is inserted into said socket and iv) a second nut mounted at an end of said second case.

2. The connector for an electronic appliance as claimed in claim 1, further comprising a first insulating means formed at a peripheral portion of said female contact and a second insulating means formed at a peripheral portion of said male contact.

3. The connector for an electronic appliance as claimed in claim 1, wherein an interval between said female contact and an outer end of said socket is about 4 mm.

4. The connector for an electronic appliance as claimed in claim 1, wherein said connecting and separating means is a push-type connecting and separating member having a latch formed at a front portion of said member and corresponded to said locking groove.

5. The connector for an electronic appliance as claimed in claim 4, wherein said push-type connecting and separating member is comprised of an elastic material.

6. The connector for an electronic appliance as claimed in claim 5, wherein said push-type connecting and separating member is a plastic button or a metal button.

7. The connector for an electronic appliance as claimed in claim 1, wherein said connecting and separating means is a sliding-type connecting and separating member having two balls corresponding to said locking groove.

8. The connector for an electronic appliance as claimed in claim 7, wherein two locking grooves are formed at an inner peripheral portion of said first case.

9. A connector for an electronic appliance comprising:
a socket having i) a first case provided with a spiral groove at an outer peripheral portion and an inserting hole at an inner peripheral portion, ii) a first nut mounted at an end of said first case, iii) a locking groove formed at a first inner peripheral portion of said first nut and iv) a female contact formed at a central portion of said first case; and
a plug having i) a second case having a stepped cylindrical shape, ii) a male contact formed at a central portion of said second case to be contacted with said female contact, iii) a push-type connecting and separating means having a latch formed at front portion of said means and corresponded to said locking groove, said means being mounted at a portion where said second case is inserted into said socket and iv) a second nut mounted at an end of said second case.

10. The connector for an electronic appliance as claimed in claim 9, further comprising a first insulating means formed at a peripheral portion of said female contact and a second insulating means formed at a peripheral portion of said male contact.

11. The connector for an electronic appliance as claimed in claim 9, wherein an interval between said female contact and an outer end of said socket is about 4 mm.

12. The connector for an electronic appliance as claimed in claim 9, wherein said push-type connecting and separating means is comprised of an elastic material.

13. The connector for an electronic appliance as claimed in claim 12, wherein said push-type connecting and separating means is a plastic button or a metal button.

14. A connector for an electronic appliance comprising:
a socket having i) a first case provided with a spiral groove at an outer peripheral portion and an inserting hole at an inner peripheral portion, ii) a first nut mounted at an end of said first case, iii) a locking groove formed at a first inner peripheral portion of said first nut and iv) a female contact formed at a central portion of said first case; and
a plug having i) a second case having a stepped cylindrical shape, ii) a male contact formed at a central portion of said second case to be contacted with said female contact, iii) a sliding-type connecting and separating means corresponding to said locking groove, said sliding-type connecting and separating means being mounted at a portion where said second case is inserted into said socket and iv) a second nut mounted at an end of said second case.

15. The connector for an electronic appliance as claimed in claim 14, further comprising a first insulating means formed at a peripheral portion of said female contact and a second insulating means formed at a peripheral portion of said male contact.

16. The connector for an electronic appliance as claimed in claim 14, wherein an interval between said female contact and an outer end of said socket is about 4 mm.

17. The connector for an electronic appliance as claimed in claim 14, wherein two locking grooves are formed at an inner peripheral portion of said first case.

18. The connector for an electronic appliance as claimed in claim 17, wherein said slide-type connecting and separating means has two balls respectively corresponding to said locking grooves.

19. A connector for an electronic appliance comprising:
a socket having i) a first case provided with a spiral groove at an outer peripheral portion and an inserting hole at an inner peripheral portion, ii) a first nut mounted at an end of said first case, iii) a connecting and separating means mounted at a first inner peripheral portion of said first nut and iv) a female contact formed at a central portion of said first case; and
a plug having i) a second case having a stepped cylindrical shape, ii) a male contact formed at a central portion of said second case to be contacted with said female contact, iii) a locking groove corresponding to said connecting and separating means and being formed at a portion where said second case is inserted into said socket and iv) a second nut mounted at an end of said second case.

20. The connector for an electronic appliance as claimed in claim 19, wherein said slide-type connecting and separating means has two balls respectively corresponding to said locking groove.
